(19) United States
(12) Patent Application Publication
(10) Pub. No.: US 2024/0242187 A1
(43) Pub. Date: Jul. 18, 2024

(54) SYSTEMS AND METHODS FOR DYNAMIC SYSTEM SELECTION

(71) Applicant: Truist Bank, Charlotte, NC (US)

(72) Inventor: Prasad Prabhakarrao Jahagirdar, Fort Mill, SC (US)

(73) Assignee: Truist Bank, Charlotte, NC (US)

(21) Appl. No.: 18/156,172

(22) Filed: Jan. 18, 2023

(51) Int. Cl. G06Q 20/10

(52) U.S. Cl. CPC G06Q 20/102

(57) ABSTRACT

A system is disclosed for dynamically selecting a system for completing an interaction. The system as a whole includes a first system and a second system, each having their own processor, memory, and communication interface. The system receives user identifying information from a user computing device. The system receives an indication from the user computing device to complete an interaction between a first source and a second source. Based on the combined factors of the user identifying information, the type of source of the first source, and the type of source of the second source, the system determines an appropriate system between the first system and the second system for completing the indicated interaction. After determining the appropriate system, the system transmits the indication to complete the interaction to the appropriate system for completion of the interaction.

### FIELD

This invention relates generally to the field of dynamic system selection, and more particularly, embodiments of the invention relate to dynamically selecting a system to complete an interaction between a first source and a second source based on identifying information for a user and the type of source of the first source and the second source.

### BACKGROUND

When a company merges with or acquires another company or entity, changes are necessary to integrate the previous systems into a harmonious system easily maneuverable by all parties, including customers and employees. When the merger occurs, it may take considerable time to get all systems consolidated between the two or more entities. In the interim, rules and policies must be put in place to ensure that users remain satisfied with the newly formed entity and continue to conduct business with that entity.

Accordingly, a need exists for systems and methods for selecting the appropriate account to complete an interaction based on the particular user and the interaction that they wish to complete. The systems and methods described herein constitute an improvement in conventional computer processing and data storage technology processes and has a practical application when utilized by, for example, a banking entity that has merged with another banking entity. By making the user experience seamless by processing transactions based on a rule engine that takes into account multiple factors to determine which banking system will process the transaction. In existing implementations, a user would have to log into multiple banking systems just to complete a single interaction. This can be a strain on existing resources for current systems to try to reconcile which system processed which interaction. It also causes inconveniences for users that may result in a loss of their business if they are not able to use the current systems efficiently. Advantageously, this issue can be bypassed by means of the systems and methods described herein.

### BRIEF SUMMARY

Embodiments of the present invention address the above needs and/or achieve other advantages by providing systems and methods to ensure user interactions are completed smoothly, without affecting the user experience.

According to example embodiments of the invention, a method for dynamic system selection for completing an interaction includes receiving user identifying information from a user computing device having at least one processor, a memory, and a communication interface. The method also includes receiving a selection, from the user computing device, of an interaction between a first source and a second source, wherein the first source is associated with a first type of sourced and the second source is associated with a second type of source. At least partially based on the user identifying information, the first type of source, and the second type of source, the method includes determining whether the selected interaction should be completed by a first system or a second system. In response to determining whether the interaction should be completed by the first system or the second system, the method further includes transmitting the selection of the interaction to at least one of the first system and the second system for completion.

Embodiments of the invention include a system for dynamic system selection for completing an interaction, where the system includes a first system having a first memory, a first processor, a first plurality of programming instructions stored in the first memory and operating on the first processor, and a first communication interface communicatively coupled to the first processor. The system further includes a second system having a second memory, a second processor, a second plurality of programming instructions stored in the second memory and operating on the second processor, and a second communication interface communicatively coupled to the first processor and to the second processor. The first system is configured to receive user identifying information from a user computing device comprising at least one processor, a memory, and a communication interface, where the user computing device communication interface is communicatively coupled to the first system. The first system is further configured to receive an indication from the user computing device to complete an interaction between a first source and a second source. At least partially based on the user identifying information, the first source, and the second source, the system determines an appropriate system between the first system and the second system for completing the indicated interaction. In response to determining the appropriate system for completing the indicated interaction, the first system transmits the indication to complete the interaction to the appropriate system for completion of the interaction.

Embodiments of the invention include a back-end server system for dynamic system selection for completing an interaction, where the system includes a first system and a second system. The first system has a first memory, a first processor, a first plurality of programming instructions stored in the first memory and operating on the first processor, and a first communication interface communicatively coupled to the first processor. Similarly, the second system has a second memory, a second processor, a second plurality of programming instructions stored in the second memory and operating on the second processor, and a second communication interface communicatively coupled to the first processor and to the second processor. The system is configured to receive user identifying information from a user device comprising at least one processor, a memory, and a communication interface. The first system is further configured to receive an indication to initiate an interaction between a first source and a second source. At least partially based on the user identifying information, a first source type associated with the first source, and a second source type associated with the second source, the first system determines whether the interaction should be completed by the first system or the second system. In response to determining whether the interaction should be completed by the first system or the second system, the system transmits the indication to initiate the interaction to at least one of the first system and the second system. In response to transmitting the indication to initiate the interaction to at least one of the first system and the second system, the selected system initiates the interaction between the first source and the second source. In response to initiating the interaction between the first source and the second source, the system transmits a notice of completed interaction to a user interface communicatively coupled to the user device.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for dynamic selection of a system for completing an interaction, in accordance with an embodiment of the present invention.

FIG. 2 is a flowchart illustrating a method for dynamically selecting a system to complete a user requested interaction, according to at least one embodiment.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

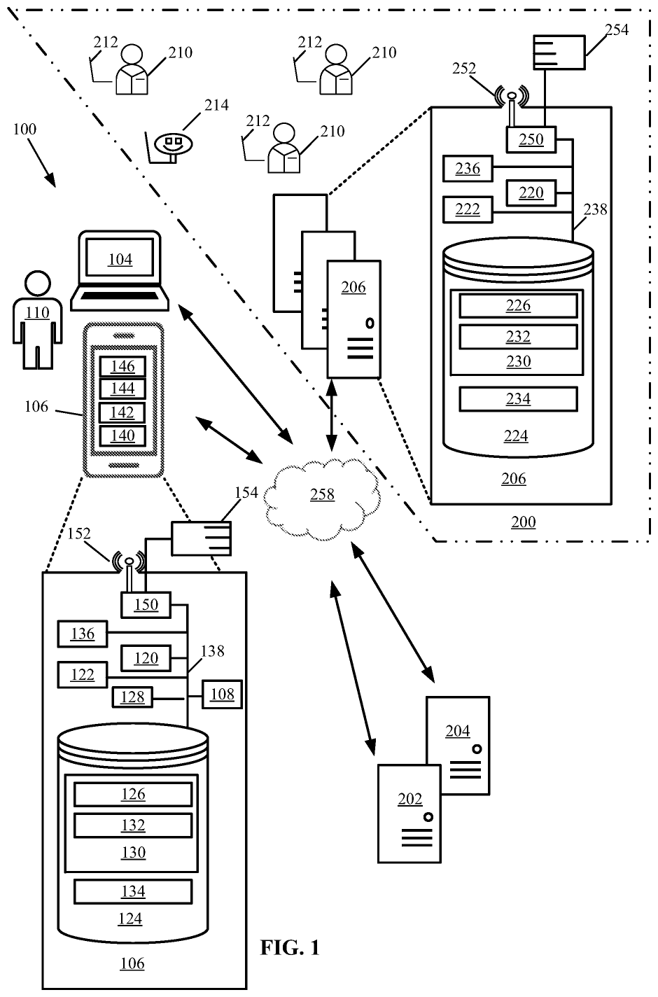

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be, for example, a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, a contactless communication device, and other transceivers. In addition, GPS (Global Positioning System) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, the agent devices 212, the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

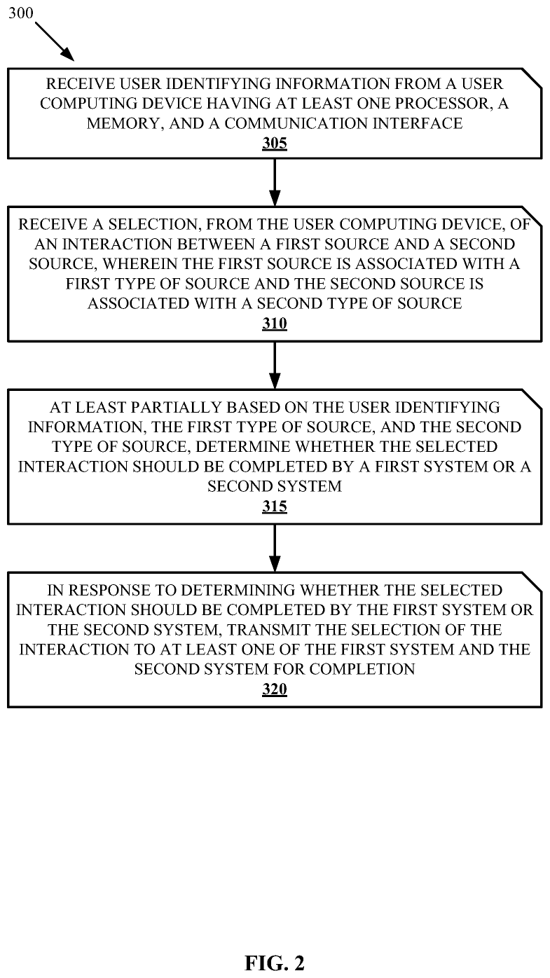

FIG. 2 is a flow chart representing a method 300, according to at least one embodiment, for dynamically selecting a particular system to complete an interaction. In particular embodiments, the system 300 allows a user to complete an interaction or transaction that may require a different system than what the user has logged in to or the system that they are currently using without inconveniencing the user by making them switch to a different system that will actually complete the transaction. The system determines which system will process or complete the interaction based on the following factors: (1) the user type, (2) the account the user has selected as the “from” account, and (3) the account the user has selected as the “to” account.

The first step, as represented by block 305, is to receive user identifying information from a user computing device having at least one processor, a memory, and a communication interface. The system may receive the information directly from the user via a web-based browser or dedicated application. In some embodiments, the user may need to login to the web-based browser or dedicated application using basic credentials such as a username and password. In particular embodiments, the more advanced credentials may be required such as biometric data, a personal identification number, and/or a two-step verification protocol for allowing the user to log in. In example embodiments, the user identifying information includes any one or more identifiers associated with the user such as the user's: (1) name; (2) phone number; (3) account number; (4) code number or identifier indicating which entity the user is a client or customer with; and/or (5) other profile data.

In example embodiments, the login information is received with a request for remote user access to the user account from a user device over the Internet. The login information may be received after a back-end server system initiates a request or from the web-based browser based on directions from the online banking platform (which may come from a back-end server system or another entity system), or may originate from the dedicated mobile application. The login information may be received after the user is presented a pop-up window or online with the application or web-site content. The system may also receive the login information in response to a user attempting to navigate to information, such as account information, that is confidential and is only disclosed upon basic user authentication. In some embodiments, the login information may include a secondary level of authentication, or two-factor authentication, in addition to the basic username and password. For example, the system, upon receipt of the basic login information, may send a one-time code to the user's mobile device that must be input from the user device into the web-based browser or dedicated mobile application to gain full access to the user's account(s).

In various embodiments, once the login information has been received, the system will verify and authenticate the login information. The back-end server system may determine whether the submitted login information is sufficient to authenticate the user for remote access. If so, the system will generate and transmit a user authentication confirmation over the Internet to the user device to grant remote user access to the user device.

In example embodiments, the identifying information may include that the user is a customer or client of a financial institution. In some embodiments, the user may be a customer or client of more than one financial institution, where the financial institutions may or may not be associated with one another. The identifying information may be stored in a user account or on a web-based browser or dedicated application having an access control platform. The user account is associated with an entity with which the user holds at least one account, product, or other relationship. The web-based browser may be navigated to a website for the entity. The dedicated application may be a mobile application downloaded from an app store or other application hub for mobile devices. In example embodiments, the user account may only be accessed after the basic or advanced credentials have been input and authorized by the access control platform.

Next, at block 310, the method continues by receiving a selection, from the user computing device, of an interaction between a first source and a second source, where the first source is associated with a first type of source and the second source is associated with a second type of source. In example embodiments, the interaction between the first source and the second source includes any suitable interaction, transaction, or exchange such as online payment, wire transfer, ACH transfer or transaction, loan payment, mortgage payment, or any other online bill-pay. Thus, the interaction may be any suitable transaction, product, or service offered to a user by a first or second entity, where the user selects or has selected as a payment or resource sending or receiving source or account. In example embodiments, the resource may be any suitable resource, currency, or fund that may be transferred, exchanged, received, or purchased. For example, the resource may be a particular USD amount.

In example embodiments, the first and second source are each an account associated with an entity with which the user holds at least one account. In particular embodiments, the type of source may be any suitable type of account including, but not limited to, a checking account, a savings account, a money market account, a certificate of deposit, a mortgage account, a loan account, a retirement account, and/or a brokerage account. In some embodiments, the first type of source and the second type of source are different and in other embodiments, they may be the same type of source.

In example embodiments, the first source may be associated with a first entity, and the second source may be associated with either the first entity or a second entity. In particular embodiments, the first and/or second entity include a financial institution or banking provider. For example, the first source may be a checking account at a first financial institution, and the second source may be a checking account at a second financial institution. Similarly, the first source may be a checking account at a first financial institution, and the second source may be a different checking account at the same financial institution. In alternate embodiments, the first and second entity may be any suitable entity for exchanging, trading, buying, or selling resources. For example, as opposed to a traditional banking entity, the first and second entity may include entities that are decentralized computing systems that allow users to have accounts for interactions or transactions using distributed ledger technology (i.e., cryptocurrency networks).

The next step, as represented by block 315, is to determine whether the selected interaction should be completed by a first system or a second system at least partially based on three factors including: (1) the user identifying information; (2) the first type of source; and (3) the second type of source. In some embodiments, the system may also take into consideration the type of transaction that has been selected, or any other form of data or information the system may have, as one of the factors for determining which system will complete the transaction. Thus, once the system receives the user identifying information and the request or selection to initiate or complete an interaction between the first source and the second source, the user identifying information and the source types will include various parameters or attributes that allow the system to determine whether the selected interaction should be completed by the first system or the second system. For example, where the user identifying information includes that the user is a customer of a first bank, and the user has selected to transfer money from a checking account held with the first bank to an external account such as a credit card account at a second financial institution, each of these factors will include data or codes that the system will use to determine which system will actually process or complete the transfer or interaction. In this example, because it is an external account that the user has selected and because the interaction selected is an electronic transfer of funds, the system may determine that the second system should complete the interaction. However, it should be understood that any processing logic or rule engine may be implemented based on the parameters, factors, codes, or attributes that are received, selected by the user, or determined based on the type of source and the user identifying information. In some embodiments, one factor may have greater significance in deciding which system to complete the interaction. For example, the rule engine may include a rule that any bill pay transaction will be completed by the second system, regardless of the user identifying information, the “from” or first account, or the “to” or second account. In alternate embodiments, all three factors may be necessary to determine which system should complete the interaction. In other embodiments, additional factors or identifiers may be required to choose either the first system or the second system to complete the interaction.

In example embodiments, the first system has a first memory, a first processor, a first plurality of programming instructions stored in the first memory and operating on the first processor, and a first communication interface communicatively coupled to the first processor. Similarly, the second system includes a second memory, a second processor, a second plurality of programming instructions stored in the second memory and operating on the second processor, and a second communication interface communicatively coupled to the first processor and to the second processor. In example embodiments, the first system is associated with a first entity and the second system is associated with a second entity. In some embodiments, both the first system and the second system are associated with the same entity. In particular embodiments, the first system is controlled and maintained by a separate entity than that which controls and maintains the second system. In other embodiments, both systems are controlled and maintained by the same entity. In example embodiments, the second system may include one or more external systems. Similarly, the first system may include one or more internal systems associated with a particular entity. Thus, the first and second system may include any number of internal and external systems that may be utilized when completing a transaction.

The next step, after determining whether the selected interaction should be completed by the first system or the second system, as represented by block 320, is to transmit the selection or indication to initiate or complete the interaction to either the first system or the second system, whichever system is the appropriate system for completing the transaction. The elected, or appropriate system will then be queued by the appropriate system for completion of the transaction. The designated system will complete the transaction by, for instance, transferring a resource or funds from the first source to the second source. Similarly, the system may complete the transaction by receiving funds from the second source to the first source. In various embodiments, the system will complete the transaction as requested and selected by the user. In some embodiments, if there is a failure to complete the transaction, an indication of such failure will be sent to the user. For example, when on a web-browser, the user may receive a pop-up notification that the transaction has either been completed or that there was an error completing the interaction.

Although not shown in the figures, once the elected system completes the interaction, a notice of completed interaction will be transmitted to a user interface associated with the user's computing device. In particular embodiments where the first system completes the interaction, the notice of completed interaction may be transmitted to the user by the first system. Alternatively, in embodiments where the second system completes the transaction, the notice of completed interaction may be sent to the user device by the second system. In still another embodiment, where the second system completes the transaction, the notice of completed transaction may first be sent to the first system for future notification by the first system to the user device.

In example embodiments, once the interaction has been completed, at least one system will create a consolidated list of transactions from both the first system and the second system. In embodiments where the first and second system include any number of internal and external systems, for example, where a user has multiple accounts across multiple different banking institutions, the system will compile and consolidate all transactions with the first source across all accounts into a single list onto the same webpage. This integrated digital platform experience provides a seamless end user experience because all transactions are in one location and are easily accessible by the user. The single screen graphical user interface allows a user to view all business services and business products that the customer or client has used in one place.

In example embodiments, when viewing the consolidated list of transactions, the system may load only a set number to make the load time faster. For example, if a user has 500 transactions, it would take the system a while to load every transaction, and may result in the website displaying a blank page to the user on the user interface. To prevent this delay, the system loads a predetermined number or preselected timeframe of transactions by default. When the user scrolls down the page, more transactions will load based on the default number or timeframe of transactions. For example, if the default is 25 transactions, when the user accesses the website, 25 transactions will load, and as the user scrolls down through the webpage, another 25 will load, and so on. Thus, a general user experience may include a user that has one or more accounts with a first bank that has merged with a second bank, where the user also has one or more other accounts. Based on the parameters of the user login, which include the user identifying information, it does not matter if the user logs in to the first bank's website or mobile app or the second bank's website or mobile app, the accounts will be merged on the back-end and the user will be able to see all accounts or sources at each bank on the same webpage, creating a seamless user experience for the user.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for dynamic system selection for completing an interaction, the method comprising:
receiving user identifying information from a user computing device having at least one processor, a memory, and a communication interface;
receiving a selection, from the user computing device, of an interaction between a first source and a second source, wherein the first source is associated with a first type of source and the second source is associated with a second type of source;
at least partially based on the user identifying information, the first type of source, and the second type of source, determining whether the selected interaction should be completed by a first system or a second system; and
in response to determining whether the selected interaction should be completed by the first system or the second system, transmitting the selection of the interaction to at least one of the first system and the second system for completion.

2. The method of claim 1, wherein:
the first system comprises a first memory, a first processor, a first plurality of programming instructions stored in the first memory and operating on the first processor, and a first communication interface communicatively coupled to the first processor; and
the second system comprises a second memory, a second processor, a second plurality of programming instructions stored in the second memory and operating on the second processor, and a second communication interface communicatively coupled to the first processor and to the second processor,

3. The method of claim 1, wherein in response to determining the interaction should be completed by the first system, transmitting the selection of the interaction to the first system for completion.

4. The method of claim 1, wherein in response to determining the interaction should be completed by the second system, transmitting the selection of the interaction to the second system for completion.

5. The method of claim 1, wherein the interaction comprises at least one of bill pay, ACH transaction, and electronic transfer.

6. The method of claim 1, wherein the first type of source and the second type of source each comprise at least one of a checking account, a savings account, a money market account, a certificate of deposit, a mortgage account, a loan account, a retirement account, and a brokerage account.

7. The method of claim 1, wherein the first source is associated with a first entity.

8. The method of claim 1, wherein the second source is associated with a second entity.

9. A system for dynamic system selection for completing an interaction, the system comprising:
a first system having a first memory, a first processor, a first plurality of programming instructions stored in the first memory and operating on the first processor, and a first communication interface communicatively coupled to the first processor; and
a second system having a second memory, a second processor, a second plurality of programming instructions stored in the second memory and operating on the second processor, and a second communication interface communicatively coupled to the first processor and to the second processor,
wherein the first system is configured to:
receive user identifying information from a user computing device comprising at least one processor, a memory, and a communication interface, wherein the user computing device communication interface is communicatively coupled to the first system;
receive an indication from the user computing device to complete an interaction between a first source and a second source;
at least partially based on the user identifying information, the first source, and the second source, determine an appropriate system between the first system and the second system for completing the indicated interaction; and
in response to determining the appropriate system for completing the indicated interaction, transmit the indication to complete the interaction to the appropriate system for completion of the interaction.

10. The system of claim 9, wherein the first system is further configured to:
in response to transmitting the indication to complete the interaction to the appropriate system for completion of the interaction, initiate the interaction between the first source and the second source; and
in response to initiating the interaction between the first source and the second source, consolidate the interaction with one or more other interactions and transmit a notice of completed interaction to a user interface associated with the user computing device.

11. The system of claim 9, wherein in response to determining the appropriate system for completing the indicated interaction comprises the first system, the first system is further configured to complete the indicated interaction between the first system and the second system.

12. The system of claim 9, wherein:
the first system is further configured to:
in response to determining the appropriate system for completing the indicated interaction comprises the second system, transmit the indication to complete the interaction to the second system for completion of the interaction; and
the second system is further configured to:
complete the interaction between the first source and the second source.

13. The system of claim 9, wherein the interaction comprises sending a resource from the first source to the second source.

14. The system of claim 13, wherein the resource comprises a currency.

15. The system of claim 9, wherein the interaction comprises at least one of bill pay, ACH transaction, and electronic transfer.

16. The system of claim 9, wherein the first source and the second source each comprise at least one of a checking account, a savings account, a money market account, a certificate of deposit, a mortgage account, a loan account, a retirement account, and a brokerage account.

17. The system of claim 9, wherein the first source and the second source are associated with a first entity.

18. The system of claim 9, wherein the first source is associated with a first entity and the second source is associated with a second entity.

19. A back-end server system for dynamic system selection for completing an interaction, the system comprising:
a first system having a first memory, a first processor, a first plurality of programming instructions stored in the first memory and operating on the first processor, and a first communication interface communicatively coupled to the first processor; and
a second system having a second memory, a second processor, a second plurality of programming instructions stored in the second memory and operating on the second processor, and a second communication interface communicatively coupled to the first processor and to the second processor,
wherein the system is configured to:
receive user identifying information from a user device comprising at least one processor, a memory, and a communication interface;
receive an indication to initiate an interaction between a first source and a second source;
at least partially based on the user identifying information, a first source type associated the first source, and a second source type associated with the second source, determine, whether the interaction should be completed by the first system or the second system;
in response to determining whether the interaction should be completed by the first system or the second system, transmit the indication to initiate the interaction to at least one of the first system and the second system;
in response to transmitting the indication to initiate the interaction to at least one of the first system and the second system, initiate the interaction between the first source and the second source; and
in response to initiating the interaction between the first source and the second source, transmit a notice of initiated interaction to a user interface communicatively coupled to the user device.

20. The back-end server system of claim 19, wherein the first system is further configured to:
determine the first source type based on at least one parameter associated with the first source; and
determine the second source type based on at least one parameter associated with the second source.
